(19) United States
(12) Patent Application Publication
(10) Pub. No.: US 2026/0338343 A1
(43) Pub. Date: Oct. 29, 2026

(54) LIGHTING DEVICE FOR A MOTOR VEHICLE

(71) Applicant: VALEO VISION, Bobigny (FR)

(72) Inventors: Omar AIT-HAMMOU-HASSI, Bobigny (FR); Julien AUBERT, Bobigny (FR)

(73) Assignee: VALEO VISION, Bobigny (FR)

(21) Appl. No.: 19/124,339

(22) PCT Filed: Oct. 27, 2023
(86) PCT No.: PCT/EP2023/080165

§ 371 Date: Apr. 25, 2025

(30) Foreign Application Priority Data
Oct. 28, 2022 (FR) 2211248

(51) Int. Cl. F21S 41/30; F21S 41/40

(52) U.S. Cl. CPC F21S 41/30; F21S 41/40

(57) ABSTRACT

Disclosed is a lighting device for an automotive vehicle. The lighting device includes a first light module with a first light apparatus, a second light module with a second light apparatus, and a separation mask including a cover element that covers the first light apparatus and the second light apparatus, and a partition wall that extends parallel to an optical axis and is configured to block light rays emitted by a first light generator and oriented towards a second optical device and/or is configured to block light rays emitted by a second light generator and oriented towards a first optical device.

### TECHNICAL FIELD

The invention relates to the field of lighting and luminous signaling, more particularly in the field of automotive vehicles.

### BACKGROUND OF THE INVENTION

Automotive vehicles are provided with headlamps projecting light intended to make the vehicle clearly visible, and to light the environment around the vehicle. The shape of the light beams produced by these headlamps must allow effective lighting while complying with various automotive laws, in particular in order not to dazzle other road users.

Patent document WO 2020/025171 A1 discloses a luminous module, in particular for an automotive vehicle, comprising a collector with a reflective surface collecting and reflecting the light rays emitted by a light source in a light beam. The luminous module also comprises an optical projection device, such as a lens, specifically configured to project the light beam in question by forming an image of the reflective surface of the collector. To this end, the optical projection device has a focal point situated on the reflective surface, for example at on rear edge thereof. This type of luminous module has advantages of compactness, notably in height terms, and production simplicity. In said document, this luminous module is combined with other luminous modules to form a headlamp which, in addition to a lighting function with a cut-off that is commonly referred to as low beam, performs in particular a lighting function without a cut-off, commonly referred to as high beam. The different luminous modules can be separated by partitions.

These lighting devices are complex to manufacture, in particular due to the large number of elements that they comprise and the great precision required for the positioning thereof. In addition, these lighting devices sometimes comprise light leakages. The light leakages correspond to emissions of light rays in undesirable directions. They can cause dazzling and reduce the perceived quality of the lighting device.

### SUMMARY OF THE INVENTION

The aim of the invention is to provide a lighting device for an automotive vehicle that at least partially overcomes the above drawbacks and improves the lighting devices known from the prior art.

More specifically, the invention relates to a lighting device that is easy to assemble and free from light leakages.

The invention relates to a lighting device for an automotive vehicle, comprising:
a first luminous module comprising a first luminous unit comprising a first light generator and a first light collector provided with a reflective surface capable of reflecting light rays emitted by the first light generator in a first light beam, and a first optical device capable of projecting the first light beam along an optical axis of the lighting device,
a second luminous module comprising a second luminous unit comprising a second light generator, a second light collector provided with a reflective surface capable of reflecting light rays emitted by the second light generator in a second light beam, and a second optical device capable of projecting the second light beam along an optical axis of the lighting device, and
a separating mask comprising a cover element covering the first luminous unit and the second luminous unit, and a separating wall extending parallel to the optical axis and configured to block light rays coming from the first light generator and oriented toward the second optical device and/or configured to block light rays coming from the second light generator and oriented toward the first optical device.

The lighting device can include one or more of the following features, taken alone or in combination.

The first optical device can comprise a reflective surface configured to reflect the light beam coming from the first light collector along the optical axis of the lighting device. The second optical device can comprise a reflective surface configured to reflect the light beam coming from the second light collector along the optical axis of the lighting device.

The separating wall can comprise an edge extending parallel to the reflective surface of the optical device of the first luminous module or of the second luminous module, at a distance less than or equal to 10 mm from the reflective surface and/or substantially up to mid-height of the reflective surface.

The first optical device can be adjacent to the second optical device, and offset relative to the second optical device along the optical axis, a connecting wall parallel to the optical axis connecting the first optical device to the second optical device, said separating wall being coplanar with said connecting wall.

The first luminous module can comprise a reflective surface configured to reflect the light beam coming from the first light collector toward the first optical device, and the separating mask can comprise an interposed wall configured to block the light rays coming from the first light generator and oriented directly toward the first optical device.

The separating mask can be a one-piece element obtained by plastic injection molding.

The lighting device can comprise a third luminous module comprising a third luminous unit comprising a third light generator and a third light collector provided with a reflective surface capable of reflecting light rays emitted by the third light generator in a third light beam, and a third optical device capable of projecting the third light beam along the optical axis of the lighting device, the separating mask comprising a second separating wall extending parallel to the optical axis and configured to block light rays coming from the second light generator and oriented toward the third optical device and/or configured to block light rays coming from the third light generator and oriented toward the second optical device.

The first luminous module can be configured to perform a high beam lighting function. The second luminous module can be configured to perform a low beam lighting function.

The luminous modules can be lighting modules, that is, configured to generate one or more luminous functions for automotive lighting.

The invention also relates to a headlamp for an automotive vehicle, comprising a lighting device as defined herein.

The headlamp can comprise a housing closed by a transparent outer lens, the lighting device being accommodated inside the housing, the cover element covering the first luminous unit and the second luminous unit so that they are not visible through the outer lens.

### BRIEF DESCRIPTION OF DRAWINGS

These objects, features and advantages of the present invention will be disclosed in detail in the following non-limiting description of a particular embodiment given with reference to the appended figures, in which:

FIG. 1 is a perspective front view of a lighting device according to one embodiment of the invention.

FIG. 2 is a perspective side view of the lighting device, in which a separating mask of the lighting device is not shown.

FIG. 3 is a perspective side view of the lighting device, in which the separating mask and a one-piece optical element of the lighting device are not shown.

FIG. 4 is a perspective front view of the lighting device, in which the separating mask of the lighting device is not shown.

FIG. 5 is a perspective view of the one-piece optical element of the lighting device.

FIG. 6 is a perspective bottom view of the one-piece optical element.

FIG. 7 is a first cross-sectional side view of the lighting device, along a plane P1 identified in FIG. 1.

FIG. 8 is a second cross-sectional side view of the lighting device, along a plane P2 identified in FIG. 1.

FIG. 9 is a perspective top view of the separating mask of the lighting device.

FIG. 10 is a perspective bottom view of the separating mask of the lighting device.

FIG. 11 is a top view of the lighting device.

### DETAILED DESCRIPTION OF THE INVENTION

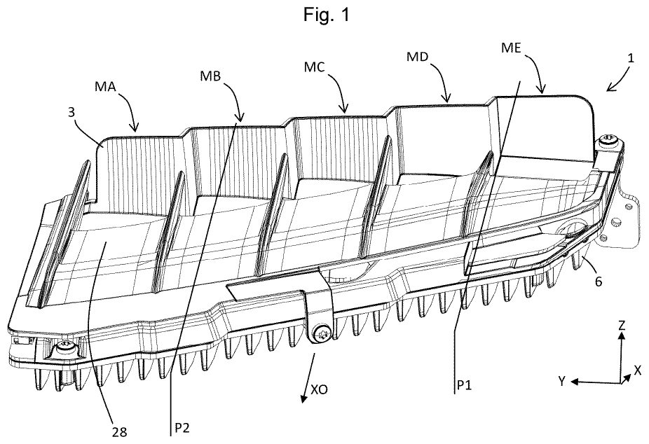

FIG. 1 illustrates a lighting device 1 for an automotive vehicle according to one embodiment of the invention. The lighting module 1 is intended to be incorporated into a headlamp of the vehicle. The headlamp is particularly a front left headlamp, left and right being defined from the point of view of a driver of the vehicle seated in the driving position. The invention could of course be transposed to a front right headlamp or even to any other headlamp of the vehicle. The lighting device 1 is accommodated in a housing of the headlamp, which is intended to be fastened to the vehicle. The housing is closed at the front by a transparent protective outer lens.

In this document, the axis X denotes the longitudinal axis of the vehicle. Moving forward and in a straight line, the vehicle advances from rear to front in a direction parallel to its longitudinal axis. The axis X is oriented from the front to the rear of the vehicle, that is to say in the reversing direction. The axis Y denotes the transverse axis of the vehicle. The axis Y is oriented from left to right. The axis Z denotes the axis perpendicular to the axis X and the axis Y. The vehicle is considered to be at rest on horizontal ground. The axis Z is a vertical axis, oriented from bottom to top. The axes X, Y and Z form an orthogonal coordinate system. This same coordinate system, defined by reference to a vehicle, will also be used to describe the lighting device 1, even when considered outside of the vehicle, since it is intended to be mounted in a specific orientation in the vehicle.

The lighting device 1 is configured to perform a low beam lighting function and to perform a high beam lighting function. The low beam lighting function is obtained by projecting a light beam with a cut-off, that is, having an asymmetry between a right-hand part and a left-hand part of the light beam, in order not to dazzle another motorist traveling in the opposite direction. In countries where traffic travels on the right, that is, where vehicles are generally instructed to drive on the right-hand part of the roadway, such a light beam can comprise a left-hand part that does not light as high as a right-hand part of the light beam. The high beam lighting function is obtained by projecting a more powerful light beam than the low beam light beam. The light beam performing the high beam function is not necessarily a light beam with a cut-off, and is mainly intended to be used in the absence of any motorists traveling in the opposite direction.

As a variant, the lighting device 1 could also be configured so that it performs only one lighting function among the low beam function and the high beam function. The light beams coming from the lighting device 1 can be generally centered around an optical axis XO substantially parallel to the axis X.

In order to perform these different lighting functions, the lighting device 1 comprises a plurality of luminous modules arranged side-by-side along the axis Y. In this instance, the lighting device 1 comprises five adjacent luminous modules MA, MB, MC, MD, and ME. As a variant, the number of luminous modules could be different, in particular at least two, three, four, six or even more luminous modules. This number can be preferably less than or equal to ten. Each luminous module can be intended to produce a light beam forming all or part of the low beam and/or high beam lighting function. Some luminous modules can for example be used to contribute to both the low beam function and the high beam function.

According to the embodiment shown, the three luminous modules MA, MB, and MC, which are positioned more toward a longitudinal mid-plane of the vehicle, are particularly intended to each produce one component of a high beam light beam. For example, a projection in a plane orthogonal to the optical axis XO of the high beam light beam can be broken down into three adjacent vertical zones, each vertical zone being lit by a separate luminous module MA, MB, or MC. The two luminous modules MD and ME, which are positioned more toward a lateral edge of the vehicle, are intended to each produce one component of a low beam light beam. A projection in a plane orthogonal to the optical axis XO of the low beam light beam can be broken down into a central zone and a peripheral zone. The central zone, commonly referred to as a “kink” zone, comprises a cut-off configured to prevent dazzling motorists traveling in the opposite direction to the vehicle. A kink light beam can be defined as a light beam having a cut-off line that comprises a point of inflection. The central zone is lit by the luminous module MD. The peripheral zone, commonly referred to as a “flat” zone, has a lower luminous intensity than the central zone, and is lit by the luminous module ME. A flat light beam can be defined as a light beam having a cut-off line that extends horizontally, without a point of inflection. The luminous module ME can also light the central zone, so that the luminous intensity of the central zone can be the result of the sum of the luminous intensities produced by the modules MD and ME.

In addition to a lighting function, the headlamp contributes greatly to the general appearance of the vehicle and therefore also has an aesthetic function. To this end, it comprises lines that blend harmoniously with the body of the vehicle. The protective outer lens of the headlamp particularly extends not parallel to the transverse axis of the vehicle but obliquely toward the rear and toward the lateral edge of the vehicle. Such a shape imposes dimensional constraints on the lighting device 1, which thus has a front face that is generally inclined relative to the optical axis XO. As this is a front left headlamp, a front face of the lighting device 1 particularly extends generally obliquely toward the left and toward the rear of the vehicle. As a result, the different luminous modules MA, MB, MC, MD, and ME are offset from each other along the optical axis XO. The luminous module ME is the luminous module that produces the widest light beam along the axis Y among the five luminous modules. It is advantageously positioned in the position closest to the lateral edge of the vehicle so that the light beam that it produces is not disrupted by a grille of the vehicle.

In addition, the lighting device 1 can be visible through the protective outer lens and particular attention must therefore also be paid to its appearance.

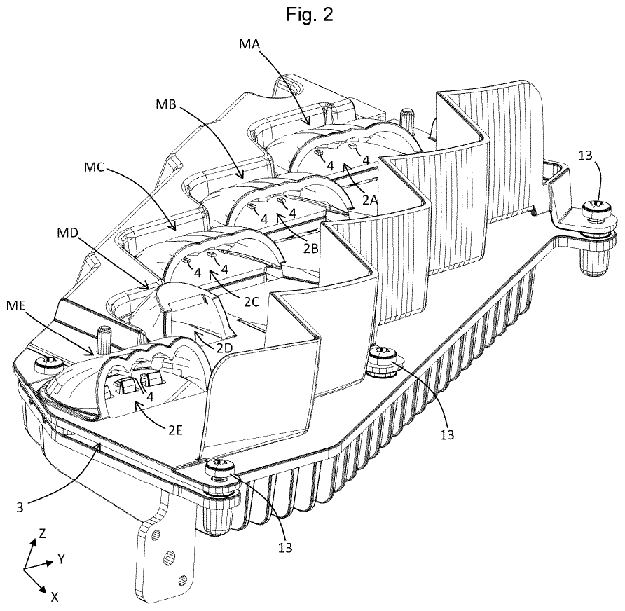

FIG. 2 illustrates the lighting device 1 without a separating mask, which forms a sort of upper cover of the lighting device. The lighting device 1 comprises a light generator 2A, 2B, 2C, 2D, 2E for each luminous module MA, MB, MC, MD, and ME, and a one-piece optical element 3 common to all of the luminous modules. In the remainder of the description, where this makes it easier to read, the suffixes A, B, C, D, and E will be added to the reference signs to denote items that belong respectively to the luminous modules MA, MB, MC, MD, and ME.

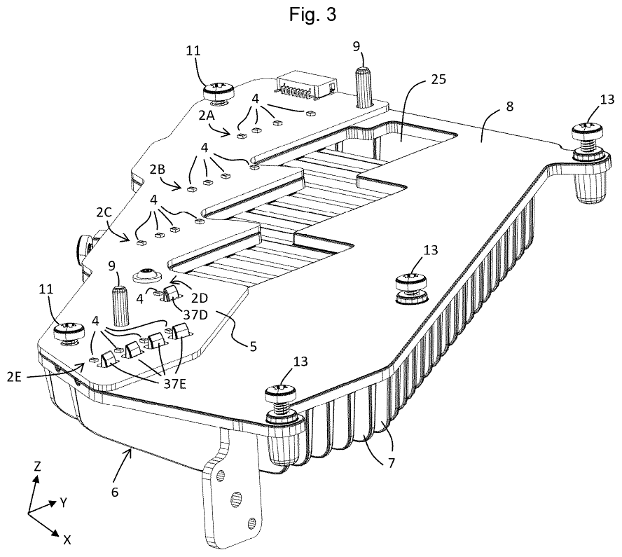

Each light generator 2A, 2B, 2C, 2D, 2E comprises at least one light source 4. The luminous modules MA, MB, MC, and ME particularly each comprise a light generator comprising four light sources 4. The luminous module MD comprises a light generator 2D comprising a single light source 4. Each light source 4 is preferably a light-emitting diode. The light sources 4 of all of the light generators 2A, 2B, 2C, 2D, 2E are connected to an upper face of one and the same printed circuit board 5. The printed circuit board 5 is clearly visible in FIG. 3, in which the one-piece optical element 3 is not shown. As a variant, each light generator 2A, 2B, 2C, 2D, 2E could comprise a different number of light sources, for example at least two, three, five, or even more light sources. This number can be preferably less than or equal to ten. The different light sources of one and the same light generator 2A, 2B, 2C, 2D, 2E are preferably positioned side-by-side along the axis Y.

An axis ZO can be defined as an axis perpendicular to a plane in which the printed circuit board 5 extends. The axis ZO can be oriented in the direction of emission of the light rays by the light sources 4, that is, upward in the embodiment shown. The axis ZO can be perpendicular to the optical axis XO, but the angle of these two axes can also be different from 90°. The angle can be between 50° and 90°, in particular between 60° and 80°. An angle close to 70° is advantageous as it makes it possible to incline the light collectors, and thus allows the light rays reflected by the optical devices to pass above said collectors and not be occulted by them, while limiting the vertical footprint of the module, which increases when the angle decreases. An axis YO can also be defined as the axis perpendicular to both the axes XO and ZO. The axes XO, YO and ZO can thus define a coordinate system, in particular an orthogonal coordinate system, relative to the headlamp, independent of the coordinate system formed by the axes X, Y and Z, which is defined in relation to the vehicle into which the headlamp is to be incorporated. The axes XO, YO and optionally ZO can be parallel or substantially parallel to the axes X, Y and Z defined above respectively, when the headlamp is mounted in the vehicle in its operating position.

The lighting device 1 also comprises a heat sink 6 provided with cooling fins 7 extending downward. The heat sink 6 comprises an upper face 8 bearing against a lower face of the printed circuit board 5, so as to dissipate the heat produced by the printed circuit board and by the light sources 4. The heat sink 6 further comprises positioning pins 9 engaging with corresponding positioning holes provided in the printed circuit board 5 and with positioning holes 10 provided in the one-piece optical element 3. The upper face 8 of the heat sink 6 and the printed circuit board 5 can extend in a substantially horizontal plane. Finally, the heat sink 6 can comprise at least one fastening lug making it possible to fasten the lighting device in the housing of the headlamp.

The lighting device 1 further comprises first fastening screw 11 engaging with threaded holes provided in the heat sink 6, with first fastening holes 12 formed in the one-piece optical element, and with fastening holes formed in the printed circuit board 5 in order to rigidly connect these elements together. The printed circuit board 5 is thus sandwiched between the upper face 8 of the heat sink and the one-piece optical element 3, and therefore held firmly. In addition, the one-piece optical element 3 is fastened directly to the heat sink 6, with second fastening screws 13 passing through second fastening holes 14 formed in the one-piece optical element 3.

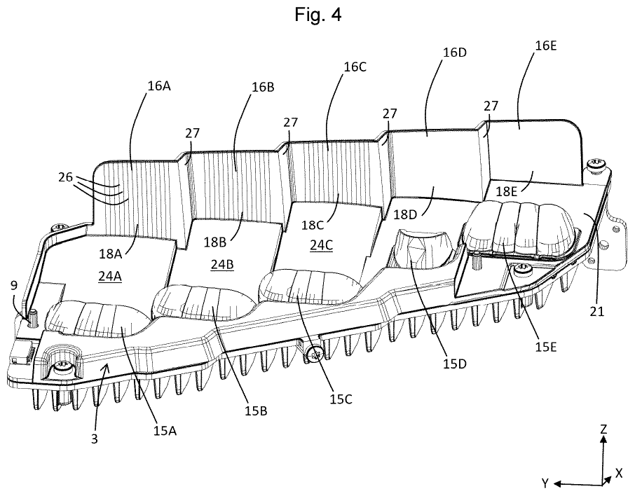

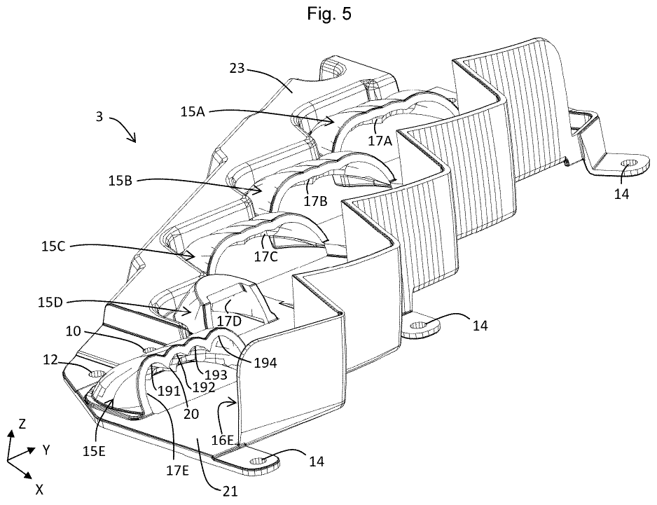

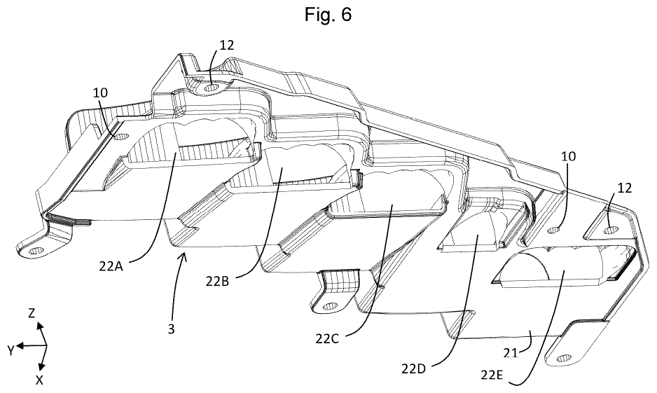

The one-piece optical element 3 is in particular clearly visible in FIGS. 4, 5, and 6. For each of the optical modules MA to ME, the one-piece optical element 3 comprises a light collector 15A, 15B, 15C, 15D, 15E and an optical projection device 16A, 16B, 16C, 16D, 16E. Each light collector 15A, 15B, 15C, 15D, 15E is intended to directly receive the light rays coming from a light generator 2A, 2B, 2C, 2D, 2E. Each light collector comprises a first reflective surface 17A, 17B, 17C, 17D, 17E configured to reflect light rays emitted by the light generator 2A, 2B, 2C, 2D, 2E in a light beam. Each optical device 16A, 16B, 16C, 16D, 16E is intended to directly or indirectly receive the light ray coming from the corresponding light collector 15A, 15B, 15C, 15D, 15E. According to the embodiment shown, each optical device 16A, 16B, 16C, 16D, 16E comprises a second reflective surface 18A, 18B, 18C, 18D, 18E configured to reflect the light ray coming from the corresponding light collector 15A, 15B, 15C, 15D, 15E, generally along the optical axis XO of the lighting device. As a variant, all or some of the optical devices 16A, 16B, 16C, 16D, 16E could comprise optical lenses through which a light beam coming respectively from the light collectors 15A, 15B, 15C, 15D, 15E is intended to pass. The light beam coming from each optical device 16A, 16B, 16C, 16D, 16E is directed toward the protective outer lens of the headlamp so as to light the road ahead of the vehicle. As the first reflective surfaces 17A, 17B, 17C, 17D, 17E and the second reflective surfaces 18A, 18B, 18C, 18D, 18E are incorporated into the same part, these reflective surfaces can be positioned ideally relative to each other, without the need for a complex assembly process. Precise light beams are thus produced. The road and/or the environment surrounding the vehicle is thus ideally lit in the desired locations.

The one-piece optical element 3 is an integrally formed part, or in other words, a monolithic part. Advantageously, the one-piece optical element 3 is obtained by plastic injection molding, that is, by a process in which plastic is injected into a manufacturing mold. Such a process makes it possible to obtain parts with very great geometric precision.

The first reflective surface 17A, 17B, 17C, 17D, 17E and the second reflective surface 18A, 18B, 18C, 18D, 18E of each luminous module MA, MB, MC, MD, or ME can be obtained by a metalizing process. A metal coating or a coating with a metallic appearance is then applied to the part resulting from the injection-molding process so as to obtain reflective surfaces.

Each light collector 15A, 15B, 15C, 15D, 15E can substantially comprise a dome shape protruding perpendicularly to the plane in which the printed circuit board 5 extends. More specifically, each first reflective surface 17A, 17B, 17C, 17D, 17E can comprise at least one paraboloidal shape, the light generator 2 being positioned at a focal point of the paraboloidal shape. The paraboloidal shape of each first reflective surface 17A, 17B, 17C, 17D, 17E is configured to collimate the light rays coming from a light generator 2A, 2B, 2C, 2D, 2E, that is, the light rays reflected by each first reflective surface 17A, 17B, 17C, 17D, 17E are substantially parallel to each other. The paraboloidal shape of the first reflective surface generally has a single focal point, that is, one region of convergence of the light rays, such that the light rays emitted by a light source 4 placed in this region of convergence are projected over a long distance after reflecting on the first reflective surface. “Projected over a long distance” means that these light rays do not converge toward a region situated at a distance of at least ten times the dimensions of the light collector 15A, 15B, 15C, 15D, 15E. In other words, the rays reflected by the first reflective surface do not converge or, if they converge, their point of convergence is situated at a distance greater than or equal to ten times the dimensions of the light collector 15A, 15B, 15C, 15D, 15E. A paraboloidal shape can optionally have parabolic portions.

Alternatively, each first reflective surface 17A, 17B, 17C of the optical modules MA, MB, MC can comprise at least one ellipsoidal shape, the light generator 2 being positioned at a focal point of the ellipsoidal shape. The ellipsoidal shape of each first reflective surface 17A, 17B, 17C is configured to converge the light rays coming from a light generator 2A, 2B, 2C, that is, the light rays reflected by each first reflective surface 17A, 17B, 17C are oriented toward a respective second focal point of each of the reflective surfaces. The ellipsoidal shape of the first reflective surface generally has two focal points, that is, two regions of convergence of the light rays, such that the light rays emitted by a light source placed in one of the two regions of convergence converge, after reflecting on the surface, toward the other region of convergence. These two focal points are situated near said surface, that is inside a space having dimensions less than ten times, and in particular less than five times, the dimensions of the reflector. An ellipsoidal shape can optionally have elliptical portions. The second focal point is positioned so that, after reflection of the light rays on the respective third reflective surface 24A, 24B, 24C, it is imaged near the focal point F of each respective second reflective surface 18A, 18B, 18C. The light rays are thus reflected by each second reflective surface 18A, 18B, 18C in the direction of the optical axis XO. This configuration is advantageous, as it makes it possible to produce a concentrated light beam.

It is also possible to have some paraboloidal first reflective surfaces and other ellipsoidal first reflective surfaces, depending on the desired shape of the beam respectively emitted by each optical module.

The association of a light generator and a light collector forms a luminous unit. According to the embodiment shown, the lighting device therefore comprises five luminous units but, as a variant, this number could be any number greater than or equal to two.

As the fourth luminous module MD comprises a single light source, the light collector 15D of this luminous module also comprises a single paraboloidal shape. The other luminous modules MA, MB, MC, and ME comprise a light collector 15A, 15B, 15C, and 15E the reflective surface 17A, 17B, 17C, 17E of which comprises as many paraboloidal portions 191, 192, 193, 194 as the light module comprises light sources 4. Each light source 4 of one and the same luminous module is positioned at a focal point of the paraboloidal shape of a portion 191, 192, 193, 194 of the light collector 15A, 15B, 15C, and 15E. In this instance, as the luminous modules MA, MB, MC, and ME comprise four light sources 4, their respective reflective surfaces 17A, 17B, 17C, 17E each comprise four paraboloidal portions 191, 192, 193, 194. These paraboloidal portions are adjacent to each other substantially along the axis Y. They are connected together by ridges 20. In order to perform a low beam function, the reflective surfaces 17D and 17E of the luminous modules MD and ME can be adapted so that they reflect light rays emitted by the light generators 2D and 2E in a light beam having a cut-off.

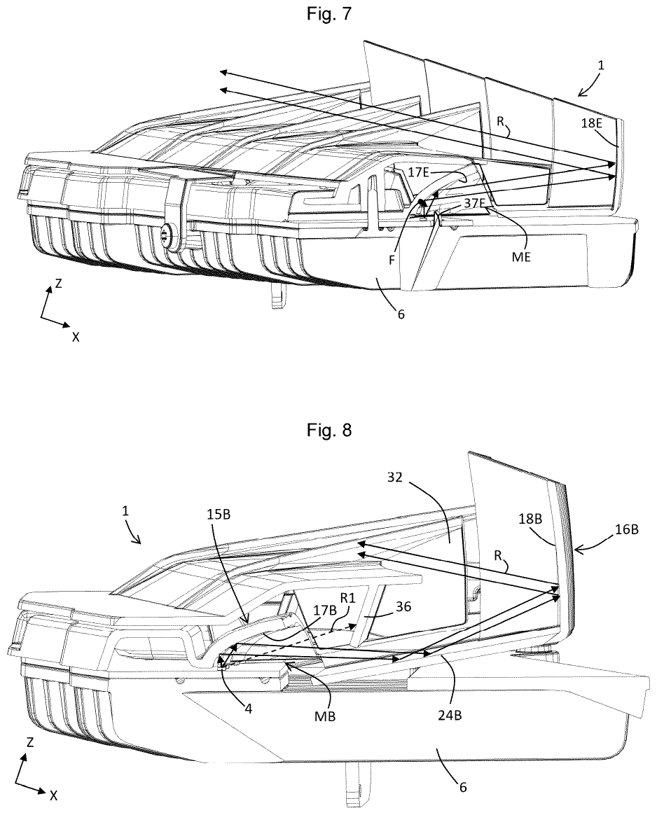

The optical device 16A, 16B, 16C, 16D, 16E of each luminous module, which could also be referred to as a reflector, extends substantially vertically and transversely, that is, at least broadly perpendicularly to the optical axis XO. It can comprise a generally rectangular outline. More specifically, each second reflective surface 18A, 18B, 18C, 18D, 18E has a generally curved shape and is provided with a focal point F (shown in FIG. 7) situated on the corresponding first reflective surface 17A, 17B, 17C, 17D, 17E, in particular on a rear edge of the reflective surface 17A, 17B, 17C, 17D, 17E.

The one-piece optical element 3 further comprises a base 21 connecting each light collector 15A, 15B, 15C, 15D, 15E to the corresponding optical device 16A, 16B, 16C, 16D, 16E. The base 21 is common to all of the luminous modules MA, MB, MC, MD, and ME. The printed circuit board 5 supporting the light generators 2A, 2B, 2C, 2D, 2E of each luminous module is positioned on a first side of the base 21 and the corresponding light collectors 15A, 15B, 15C, 15D, 15E are positioned on a second side of the base 21, opposite to the first side. According to the embodiment shown, the light collectors are positioned above the base 21 and the printed circuit board 5 is positioned below the base, but as a variant, this configuration could be reversed. The base 21 is provided with openings 22A, 22B, 22C, 22D, 22E for light rays from each light generator 2A, 2B, 2C, 2D, 2E to pass through toward the corresponding light collector 15A, 15B, 15C, 15D, 15E. The base 21 extends generally parallel to the printed circuit board 5 and comprises a surface for bearing against the printed circuit board.

The one-piece optical element 3 further comprises a part 23 forming a protective cover for the printed circuit board 5. This part 23 covers and protects the printed circuit board while allowing sufficient space for electronic components arranged on the surface of the printed circuit board.

As can be seen clearly in the cross-sectional view in FIG. 7, the light rays R (represented by arrows) coming from the light collector 15E of the luminous module ME directly reach the corresponding optical device 16E. Likewise, the light rays coming from the light collector 15D of the luminous module MD directly reach the corresponding optical device 16D. In other words, the light rays are not diverted by any other optical element interposed between the first reflective surface 17D and 17E and the second reflective surface 18D and 18E. The light rays produced by the light generators 2D and 2E therefore undergo two reflections before being projected onto the road.

Conversely, and as can be seen clearly in the cross-sectional view in FIG. 8, the light rays R coming from the light collector 15B of the luminous module MB indirectly reach the optical device 16B. Likewise, the light rays coming from the light collectors 15A and 15C of the luminous modules MA and MC indirectly reach the optical devices 16A and 16C. In particular, in each of the optical modules MA, MB, or MC, the one-piece optical element 3 comprises a third reflective surface 24A, 24B, 24C configured to reflect the light beam coming from the corresponding light collector 15A, 15B, 15C toward the corresponding optical device 16A, 16B, 16C. The three reflective surfaces 24A, 24B, 24C are flat. They are formed on an upper face of the base 21 and thus perform a vertical reversal of the image projected by each light collector 15A, 15B, 15C, which thus has greater intensity in a lower part of the light beam. Each third reflective surface 24A, 24B, 24C is therefore interposed between the corresponding first reflective surface 17A, 17B, 17C and the corresponding second reflective surface 18A, 18B, 18C in the direction of propagation of the light rays. Incorporating a third reflective surface 24A, 24B, 24C makes it possible to configure the light beam coming from the luminous module so as to perform a high beam lighting function. Each third reflective surface makes it possible to perform an upward reversal of the light beam, so that once it is reflected by the second reflective surface 18A, 18B, 18C, it is essentially situated above the horizontal, that is, angularly offset from the axis XO essentially in the positive direction of the axis ZO.

Each third reflective surface 24A, 24B, 24C extends generally in a plane inclined upwardly in the direction of the corresponding optical device 16A, 16B, 16C. Each third reflective surface 24A, 24B, 24C extends generally from an edge of the opening 22A, 22B, 22C, 22D, 22E to the base of the corresponding optical device 16A, 16B, 16C. In the same way as the reflective surfaces 17A, 17B, 17C, 17D, 17E and 18A, 18B, 18C, 18D, 18E, the third reflective surfaces 24A, 24B, 24C can be obtained by a metalizing process. The reflective surfaces 17A, 17B, 17C, 17D, 17E, 18A, 18B, 18C, 18D, 18E, 24A, 24B, and 24C can thus have a specular reflectivity of at least 85%.

Due to their inclination, the three reflective surfaces 24A, 24B, 24C can form a relief protruding in the lower face of the one-piece optical element 3. Advantageously, the upper face 8 of the heat sink 6 comprises an opening 25 (visible in FIG. 3) suitable for leaving space for the third reflective surfaces 24A, 24B, 24C of the luminous modules MA, MB, and MC. The portion of the base 21 extending between the light collector 15A, 15B, 15C, 15D, 15E and the optical device 16A, 16B, 16C, 16D, 16E of the luminous modules MD and ME is not intended to reflect light rays. This portion can optionally be grained, that is, comprise sufficient roughness, so as to prevent undesirable reflections of light rays.

According to another aspect of the invention, the second reflective surface 18A, 18B, 18C of the luminous modules MA, MB, and MC is striated perpendicularly to the optical axis XO, in particular substantially parallel to the axis ZO. The second reflective surface 18A, 18B, 18C of these luminous modules therefore comprises a set of reliefs 26 the profile of which extends substantially along the axis ZO. This makes it possible to blur the light beam coming from the lighting device and therefore soften the outlines of the projected image.

In order to correspond to the architectural lines of the headlamp in which the lighting device 1 is incorporated, the optical devices 16A, 16B, 16C, 16D, 16E of each luminous module are offset from each other along the optical axis XO. The luminous module MA is particularly the luminous module positioned furthest forward, and the luminous module ME is the luminous module positioned furthest back. The second reflective surfaces 18A, 18B, 18C, 18D, 18E are thus in a generally stepped arrangement. The distance separating the light collector 15A, 15B, 15C, 15D, 15E from the corresponding optical device can be substantially identical for all of the luminous modules. The second reflective surfaces 18A, 18B, 18C, 18D, 18E of the adjacent luminous modules are connected together by connecting walls 27 extending substantially parallel to the optical axis XO. These connecting walls 27 can be grained, so as to prevent undesirable reflections of light rays.

Finally, the one-piece optical element 3 is a part that combines a number of functions: it comprises, for each luminous module, two or three reflective surfaces that make it possible to correctly shape and orient a light beam in order to perform a lighting function, in particularly a high beam and/or low beam lighting function. It comprises reflective surfaces that interact with a plurality of light generators 2A, 2B, 2C, 2D, 2E so as to perform different lighting functions, in particular high beam lighting and low beam lighting. In addition, the one-piece optical element 3 comprises fastening means making it possible to fasten it to a heat sink and to hold the printed circuit board. The one-piece optical element 3 also comprises a part protecting the printed circuit board. The one-piece optical element 3 is both simple to manufacture and simple to assemble in a lighting device. The different reflective surfaces of one and the same luminous module are ideally positioned relative to each other, which makes it possible to achieve great optical precision. In addition, the different luminous modules are also ideally positioned relative to each other. This makes it possible to envisage performing a lighting function by means of a plurality of luminous modules each producing one part of the projected image. Each part of the projected image is thus ideally positioned relative to the others. As explained above, the lighting device could comprise only some of the luminous modules described above, in particular only one of the luminous modules described above.

The lighting device further comprises a separating mask 28 configured to optically isolate the luminous modules MA, MB, MC, MD, and ME. In addition, the separating mask 28 covers the luminous units of the lighting device, that is, the light collectors 15A, 15B, 15C, 15D, 15E and the associated light generators 2A, 2B, 2C, 2D, 2E so that they are not visible through the outer lens of the headlamp.

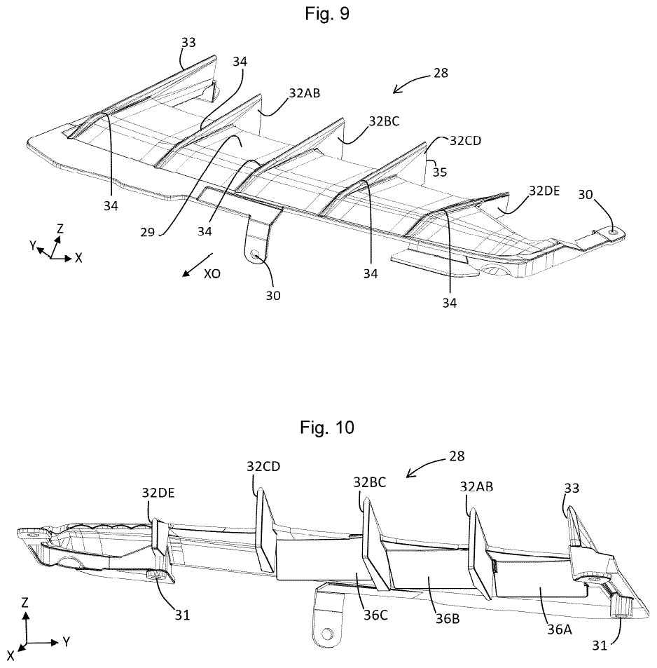

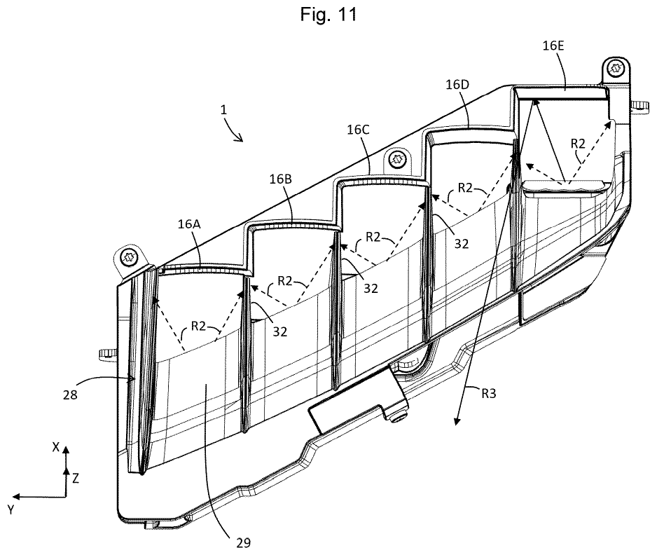

The separating mask 28 is in particular illustrated individually in FIGS. 9 and 10. It comprises a cover element 29 extending substantially horizontally above the light collectors 15A, 15B, 15C, 15D, 15E. An upper face of the separating mask 28 can be visible through the outer lens of the projector. This face can optionally support decorative elements.

The separating mask 28 comprises fastening holes 30 engaging with fastening screws in order to fasten the separating mask to the heat sink 6. It also comprises blind positioning holes 31 engaging with the positioning pins 9.

The separating mask 28 also comprises separating walls 32AB, 32BC, 32CD, 32DE extending from the cover element 29 parallel to the optical axis XO and separating the luminous modules MA, MB, MC, MD, ME. The separating walls 32AB, 32BC, 32CD, 32DE are configured to block light rays coming from the light generator 2A, 2B, 2C, 2D, 2E of a first luminous module and oriented toward the optical device 16A, 16B, 16C, 16D, 16E of a second luminous module adjacent to the first luminous module. The separating mask 28 thus comprises four separating walls 32AB, 32BC, 32CD, 32DE separating the five luminous modules MA, MB, MC, MD, and ME. As a variant, the separating mask could comprise any other number of separating walls. If the lighting device 1 comprised only two luminous modules, the separating mask 28 could comprise only one separating wall. Generally, the separating mask 28 preferably comprises a number of separating walls equal to the number of luminous modules minus one. In addition, the separating mask can comprise one or more auxiliary walls 33 parallel to the separating walls 32AB, 32BC, 32CD, 32DE, and extending along the outer edges of the lighting device 1. The separating walls 32AB, 32BC, 32CD, 32DE and the auxiliary walls 33 can be extended by ribs 34 extending longitudinally on the surface of the cover element 29. These ribs 34 increase the stiffness of the cover element 29 and are incorporated harmoniously in the extension of the walls 32 and 33.

The separating walls 32AB, 32BC, 32CD, 32DE of the separating mask 28 extend generally between the light collectors 15A, 15B, 15C, 15D, 15E and the optical devices 16A, 16B, 16C, 16D, 16E. They each comprise an edge 35 extending a short distance from a second reflective surface 18A, 18B, 18C, 18D, 18E of an optical device 16A, 16B, 16C, 16D, 16E. The distance separating the edges 35 from a reflective surface 18A, 18B, 18C, 18D, 18E can preferably be less than or equal to 10 mm, or even less than or equal to 5 mm. The clearance thus formed is sufficiently small to prevent light rays coming from the light collectors 15A, 15B, 15C, 15D, 15E from passing from one luminous module to another. The separating walls 32 are coplanar with the connecting walls 27, that is, each separating wall is arranged in the extension of a connecting wall 27.

The separating walls 32AB, 32BC, 32CD can extend substantially up to mid-height of the reflective surfaces along the axis Z or along the axis ZO. The separating wall 32DE separating the luminous modules MD and ME can however be less high than the other separating walls so that it does not block the light rays reflected by the second reflective surface 18E of the luminous module ME. The light ray produced by this luminous module has a particularly wide angle so that the sides of the road are well-lit. Generally, the separating wall situated between two luminous modules at least one of which produces a light beam having a particularly wide angle is advantageously of reduced height, compared to a separating wall situated between two modules that both produce narrow beams. Particularly wide angle is given to mean an angle greater than or equal to 25° relative to the axis XO.

The separating mask 28 further comprises interposed walls 36A, 36B, 36C configured to block light rays coming from the light generators 2A, 2B, 2C of the luminous modules MA, MB, and MC and oriented directly toward the optical devices 16A, 16B, 16C. The interposed walls 36A, 36B, 36C are therefore masks preventing direct lighting of the second reflective surfaces 18A, 18B, 18C by the light generators 2A, 2B, 2C. The interposed walls 36A, 36B, 36C comprise an upper edge by which they are connected to a lower face of the cover element 29. As can be seen in FIG. 8, the interposed walls 36A, 36B, 36C can extend downward from the cover element 29, above the third reflective surfaces 24A, 24B, 24C. The interposed walls 36A, 36B, 36C can also extend slightly obliquely in the direction of the light generator 2.

For the luminous modules MD and ME, the separating mask 28 does not comprise an interposed wall. However, the heat sink 6 advantageously comprises masking elements 37D, 37E protruding through the printed circuit board 5 by means of holes provided to this end. The masking elements 37D, 37E are interposed between each light source 4 and the optical devices 16D and 16E in order to prevent direct lighting of the optical device by the light source. As a variant, the masking elements 37D, 37E could be obtained using blocking means such as metal screens fastened to the surface of the printed circuit board 5. Such a solution could not however be used for the luminous modules MA, MB, and MC, as the blocking means arranged in this way would also block the light rays reflected by the first reflective surface and directed toward the third reflective surface.

The separating mask 28 is also a one-piece element. It is advantageously manufactured by plastic injection molding. The separating mask is not intended to reflect light rays toward a lighting zone, but conversely to block undesirable light rays. The separating mask 28 is preferably black in color so that it absorbs the light rays that reach it.

Each luminous module MA, MB, MC, MD, and ME can be activated independently of each other. When a light source 4 produces light rays, they first reach the light collector 15A, 15B, 15C, 15D, 15E. The paraboloidal shape of the first reflective surface 17A, 17B, 17C, 17D, 17E makes it possible to reorient the light rays in a selected orientation in order to perform a high beam or low beam lighting function. For the luminous modules MA, MB, and MC, the majority of the light rays are then directed toward the third reflective surface 24A, 24B, 24C and then toward the second reflective surface 18A, 18B, 18C. For the luminous modules MD and ME, the majority of the light rays are then directed directly toward the second reflective surface 18D and 18E. The rays from the luminous modules MA, MB, MC, MD, and ME then exit the lighting device by passing above the separating mask 28, and then pass through the protective outer lens of the headlamp and light the road.

As illustrated in FIG. 8 and FIG. 11, some of the light rays (shown in dashed lines) do not follow the intended trajectory and are blocked by the separating mask 28. Some light rays R1 from the luminous modules MA, MB, MC are oriented excessively upward and are blocked by the interposed walls 36A, 36B, 36C. Other light rays R2 are directed toward the second reflective surface 18A, 18B, 18C, 18D, 18E of the adjacent luminous modules and are blocked by the separating walls 32AB, 32BC, 32CD, 32DE. Some light rays R3 produced by the fifth luminous module ME are reflected by the second reflective surface 18E and then pass above the separating wall 32DE arranged between the fourth luminous module MD and the fifth luminous module ME and above the cover element 29 so that they produce a wide-angle light beam. Finally, only the correctly oriented light rays are projected outside the lighting device 1. The quality and precision of the light beams is thus optimized.

In addition, the separating mask 28 partially covers the one-piece optical element 3, which improves the aesthetics of the lighting device; the light sources 4 are also better protected from solar radiation and are less at risk of damage or excessive heating.

What is claimed is:

1. A lighting device for an automotive vehicle, comprising:
a first luminous module including a first luminous unit with a first light generator and a first light collector provided with a reflective surface capable of reflecting light rays emitted by the first light generator in a first light beam, and a first optical device-capable of projecting the first light beam along an optical axis of the lighting device,
a second luminous module including a second luminous unit with a second light generator, a second light collector provided with a reflective surface capable of reflecting light rays emitted by the second light generator in a second light beam, and a second optical device capable of projecting the second light beam along an optical axis of the lighting device, and
a separating mask including a cover element covering the first luminous unit and the second luminous unit, and a separating wall extending parallel to the optical axis and configured to block light rays coming from the first light generator and oriented toward the second optical device and/or configured to block light rays coming from the second light generator and oriented toward the first optical device.

2. The lighting device as claimed in claim 1, wherein the first optical device includes a reflective surface configured to reflect the light beam coming from the first light collector along the optical axis of the lighting device, and/or in that the second optical device includes a reflective surface configured to reflect the light beam coming from the second light collector along the optical axis of the lighting device.

3. The lighting device as claimed in claim 2, wherein the separating wall includes an edge extending parallel to the reflective surface of the optical device of the first luminous module or of the second luminous module, at a distance less than or equal to 10 mm from the reflective surface and substantially up to mid-height of the reflective surface.

4. The lighting device as claimed in claim 1, wherein the first optical device is adjacent to the second optical device, and offset relative to the second optical device along the optical axis, a connecting wall parallel to the optical axis connecting the first optical device to the second optical device, the separating wall being coplanar with the connecting wall.

5. The lighting device as claimed in claim 1, wherein the first luminous module includes a reflective surface configured to reflect the light beam coming from the first light collector toward the first optical device, and in that the separating mask includes an interposed wall configured to block the light rays coming from the first light generator and oriented directly toward the first optical device.

6. The lighting device as claimed in claim 1, wherein the separating mask is a one-piece element obtained by plastic injection molding.

7. The lighting device as claimed in claim 1, further comprising a third luminous module including a third luminous unit with a third light generator and a third light collector provided with a reflective surface capable of reflecting light rays emitted by the third light generator in a third light beam, and a third optical device capable of projecting the third light beam along the optical axis of the lighting device, the separating mask includes a second separating wall extending parallel to the optical axis and configured to block light rays coming from the second light generator and oriented toward the third optical device and/or configured to block light rays coming from the third light generator and oriented toward the second optical device.

8. The lighting device as claimed in claim 1, wherein the first luminous module is configured to perform a high beam lighting function, and/or in that the second luminous module is configured to perform a low beam lighting function.

9. A headlamp for an automotive vehicle, comprising at least one lighting device, the at least one lighting device includes a first luminous module including a first luminous unit with a first light generator and a first light collector provided with a reflective surface capable of reflecting light rays emitted by the first light generator in a first light beam, and a first optical device capable of projecting the first light beam along an optical axis of the lighting device, a second luminous module including a second luminous unit with a second light generator, a second light collector provided with a reflective surface capable of reflecting light rays emitted by the second light generator in a second light beam, and a second optical device capable of projecting the second light beam along an optical axis of the lighting device, and a separating mask including a cover element covering the first luminous unit and the second luminous unit, and a separating wall extending parallel to the optical axis and configured to block light rays coming from the first light generator and oriented toward the second optical device and/or configured to block light rays coming from the second light generator and oriented toward the first optical device.

10. The headlamp as claimed in claim 9, further comprising a housing closed by a transparent outer lens, the lighting device being accommodated inside the housing, with the cover element covering the first luminous unit and the second luminous unit so that they are not visible through the outer lens.

11. The lighting device as claimed in claim 2, wherein the separating wall includes an edge extending parallel to the reflective surface of the optical device of the first luminous module or of the second luminous module, at a distance less than or equal to 10 mm from the reflective surface or substantially up to mid-height of the reflective surface.
